(19) United States
(12) Patent Application Publication
(10) Pub. No.: US 2008/0124046 A1
(43) Pub. Date: May 29, 2008

(54) VIDEO RECORDING/PLAYING APPARATUS

(76) Inventors: Yoshitaka Hiramatsu, Sagamihara (JP); Nobuhiro Sekimoto, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/942,832

(22) Filed: Nov. 20, 2007

(30) Foreign Application Priority Data
Nov. 22, 2006 (JP) 2006-314982

(51) Int. Cl. G04F 1/04

(52) U.S. Cl. 386/95; 386/E05.001

(57) ABSTRACT

A video recording/playing apparatus, for recording or playing video data comprises a contents information extraction unit for extracting content information displaying contents from video data under reception or playback thereof, differing from the video data, and a recording/playing control unit for controlling recording or playing of a first contents corresponding to a first contents information, upon basis of the first contents information, which is extracted within the contents information extraction unit.

### BACKGROUND OF THE INVENTION

The present invention relates to a video recording/playing apparatus, in the technical field relating thereto, and for example, it relates to recording upon basis of the video being played.

Conventionally, when programming for recording a program, which is known through a newspaper, a magazine, Web site, for example, a user inputs the program information, including a broadcast channel and broadcast date/time, etc., into a recording and playing apparatus. In recent years, with widely using of an electronic broadcast program guide (EPG) transmitted through broadcast waves and/or Internet, it is possible for a user to obtain the electronic broadcast program guide with using the recording and playing apparatus or a PC, and to select programs that the user wishes to record.

Also, it is proposed that a user can reserves for watching a program. For example, in the following Patent Document 1 is described “to provide a program recording reservation apparatus which can display programs associated recorded program in recording and playing apparatus, and reserve video recording programs which a user want to watch in the programs”, and as a dissolving means is described “comprising: a recording means 11 for recording a program and program information, which are provided on broadcast signals or information signals through communication lines; a program extracting means 3 for selecting/extracting the program associated the past programs or the present programs, when playing/watching the program, which is recorded in the recording means 11; a display means 9 for displaying the program and the program information, which are selected/extracted by the program extracting means 3; a selecting means 13 for selecting a program which a user want to watch from between the programs displayed on the display means 9; and recording program means 1 and 12 for reserving a setting for recording the program, which is selected within the selecting means 13″.

[Patent Document 1]: Japanese Patent Laying-Open No. 2006-174367 (2006)

### BRIEF SUMMARY OF THE INVENTION

On the other hand, for example, other program may be introduced on a commercial (i.e., CM, or a program promotion), which is broadcasted between the programs watching.

In many cases, the other program, which is advertised or promoted in the CM, for example, may be a program of other genre or category from the program watching, in many cases, and with the apparatus disclosed in the Patent Document 1 mentioned above, it is impossible to reserve program recording.

Also, the programs and/or CMs guides not only limited to the broadcast programs, but also WEB contents and/or programs, it can be considered that which television apparatus or a recorder connecting Web and/or a communication network can record the contents. But it is also impossible to reserve recording such contents, with the apparatus disclosed in the Patent Document 1 mentioned above.

Further, the programs, which are provided on the broadcasting and the communication, and WEB contents on the WEB, as well, they are also called, collectively, as “contents”.

Then, for dissolving the problems mentioned above, for example, according to the present invention, there is provided a recording and playing apparatus, enabling to reserve easily recording of the contents from contents guidance, such as, the program promotion, etc.

In more details thereof, according to the present invention, there is provided a video recording/playing apparatus, for recording or playing video data, comprising: a contents information extract unit, which is configured to extract information of contents to differ from video data receipting or playing; a recording/playing control unit, which is configured to control recording or playing of a first contents corresponding to a first contents information, upon basis of said first contents information, which is extracted within said contents information extract unit.

According to the means mentioned above, for example, usability for a user is improved.

The problem, the means and the effects mentioned above are only examples, and others than those will be shown in a column of embodiments.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 shows an example of function block structures of a recording and playing apparatus, according to an embodiment 1 of the present invention;

FIG. 2 shows an example of hardware construction of the recording and playing apparatus;

FIG. 3 shows an example of a recording reservation confirmation screen, which a recording reservation program selection unit in the recording and playing apparatus produces and displays on a display unit thereof, according to the embodiment 1;

FIG. 4 shows another example of the recording reservation confirmation screen, which the recording reservation program selection unit in the recording and playing apparatus produces and displays on the display unit thereof, according to the embodiment 1;

FIG. 5 shows further another example of the recording reservation confirmation screen, which the recording reservation program selection unit in the recording and playing apparatus produces and displays on the display unit thereof, according to the embodiment 1;

FIG. 6 shows other example of a screen, which the recording reservation program selection unit in the recording and playing apparatus produces and displays on an display device thereof, according to the embodiment 1;

FIG. 7 shows an example of a screen to be displayed on the display device when receiving an input of an automatic recording condition, within an automatic recording condition input unit in the recording and playing apparatus, according to the embodiment 1;

FIG. 8 shows a flowchart of an example of processing within a contents information extraction unit in the recording and playing apparatus, according to the embodiment 1;

FIG. 9 shows a flowchart of an example of extracting program information in the recording and playing apparatus, according to the embodiment 1;

FIG. 10 shows a flowchart of an example of processing within a recording program unit in the recording and playing apparatus, according to the embodiment 1;

FIG. 11 shows an example of a playback selection screen, which the recording program unit produces, in the recording and playing apparatus, according to the embodiment 1;

FIG. 12 shows a flowchart of an example of processing within a recording execution unit in the recording and playing apparatus, according to the embodiment 1;

FIG. 13 shows a flowchart of an example of recording reservation of a program shown on a program promotion, in the recording and playing apparatus, according to the embodiment 1;

FIG. 14 shows an example of function block structures of a recording and playing apparatus, according to an embodiment 2 of the present invention;

FIG. 15 shows a flowchart of an example of processing within the contents information extraction unit in the recording and playing apparatus, according to the embodiment 2;

FIG. 16 shows a flowchart of an example of extracting program information in the recording and playing apparatus, according to the embodiment 2;

FIG. 17 shows a flowchart of an example of processing within a contents download setting unit in the recording and playing apparatus, according to the embodiment 2;

FIG. 18 shows a flowchart of an example of download processing of network contents, in the recording and playing apparatus according to the embodiment 2;

FIG. 19 shows an example of a download confirmation screen, which a download selection unit in the recording and playing apparatus produces and displays on the display device thereof, according to the embodiment 2; and

FIG. 20 shows an example of a screen to be displayed on the display device when receiving an input of an automatic download condition, within an automatic recording condition input unit in the recording and playing apparatus, according to the embodiment 2.

### DETAILED DESCRIPTION OF THE PREFERRED EMBODIMENTS

Hereinafter, explanation will be made on an embodiment of the present invention, in particular, by referring to an example of a recording and playing apparatus, i.e., a video recording/playing apparatus. However, as the recording and playing apparatus can be considered, not only a recorder of stationary type, for recording on so-called a HDD or an optical disc, but also a television apparatus having a video recording function, a personal computer enabling a built-in or an external television tuner, a mobile telephone, a digital camera, and so on.

### Embodiment 1

In an embodiment 1, explanation will be made on recording reservation, in particular, of a broadcast program, among the contents. Herein, the broadcast is done through terrestrial wave digital/analog broadcast, a satellite, or a cable from a TV station. Also, it may be a program of IPTV, which is transmitted through communication lines. Those broadcast and communication may also be called, collectively, “distribution”. Also, in particular, a motion video will be explained, as an example of the video.

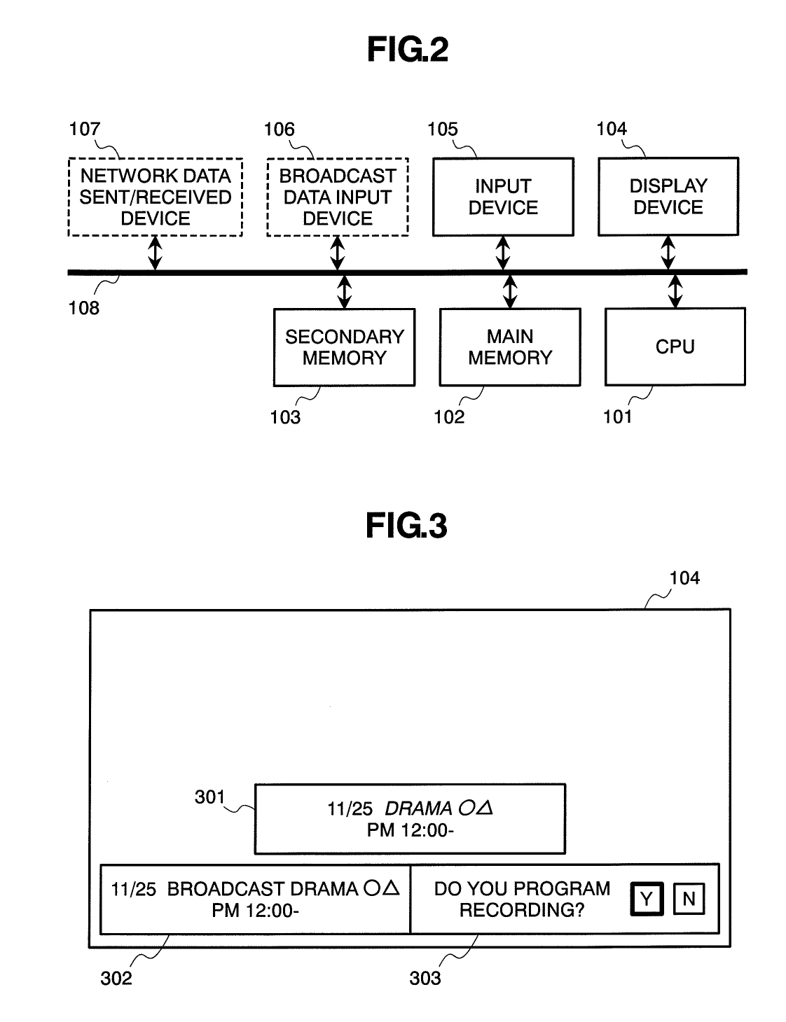

FIG. 2 shows an example of the hardware structures of the recording and playing apparatus, according to the embodiment 1.

The recording and playing apparatus comprises a CPU 101, a main memory 102, a secondary memory 103, a display device 104, and an input device 105. Further, it also comprises a broadcast data input or obtain device 106, in case when receiving a broadcast data to obtain a motion video data and/or an electronic (broadcast) program guide therefrom. Also, it further comprises a network sending/receiving device 107, when obtaining the video data and/or electronic (broadcast) program through a network. Each of the devices 101 to 107 are interconnected through a bus 108 for data transfer between them.

The CPU 101 executes the program(s) stored within the main memory 102 or the secondary memory 103.

The main memory 102 can be implemented, for example, with a random access memory (RAM) or a read only memory (ROM), etc. The main memory 102 stores therein the program(s) to be executed by the CPU 101, and/or the data and the motion video data or the like, which should be processed by the recording and playing apparatus.

The secondary memory 103 can be implemented, for example, with hard disc drives (HDDs), optical disc drives, such as, Blu-ray Discs or a DVDs, etc., magnetic disc drives, such as, floppy discs (a trade mark registered), etc., or non-volatile memories, such as, flash memories, etc., in a single body or in combination of these. The secondary memory 103 stores therein the software program(s) to be executed by the CPU 101, and/or the data and the motion video data or the like, which should be processed by the recording and playing apparatus.

The display device 104 can be implemented, for example, with a liquid crystal display, a plasma display, or projector, etc., and it display thereon the motion video to be processed by the present recording and playing apparatus, and/or display data for indicating operation settings and state of the present recoding apparatus.

The input device 105 can be implemented, for example, with a remote controller, a keyboard, a mouse, etc., and a user inputs an instruction, in relation to recording or playing, etc., through operation of this input device 105.

The broadcast data input device 106 can be implemented, for example, with a tuner or the like, and it stores the motion video data on a channel, which the user selects from the broadcast waves received on an antenna, into the secondary memory 103.

The network data sent/received device 107 can be implemented, for example, with a network card, such as, a LAN card, etc., and it obtains the motion video data and the electronic program guide from other device, which are connected through the network, and thereby stores them into the secondary memory 103.

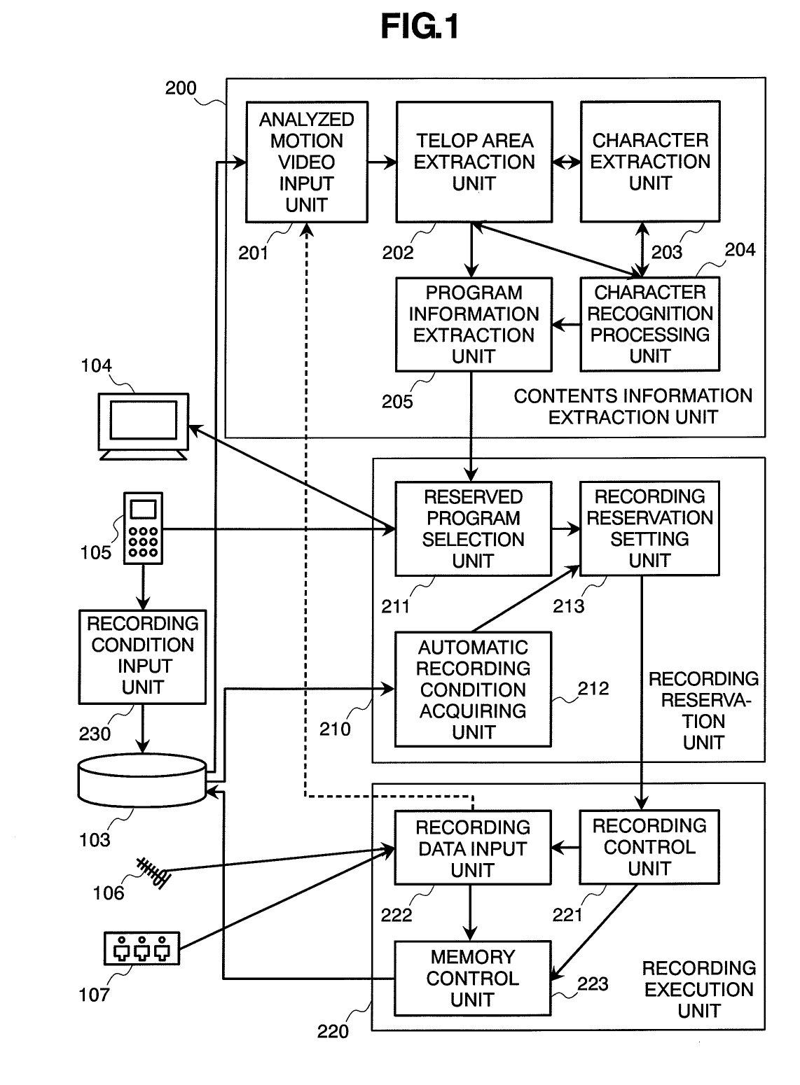

FIG. 1 shows an example of function blocks for reservation recording of a broadcast program shown on the broadcast program promotion, within the recording and playing apparatus. A part or the entire of the function blocks may be implemented with software which is stored within the main memory 102 or the secondary memory 103 shown in FIG. 2, to be executed by the CPU 101. Or it may be implemented with hardware. Hereinafter, as an example of this, explanation will assume that the entire of those function blocks are software programs, which are executed by the CPU 101.

The function blocks of the recording and playing apparatus comprises the following blocks, i.e., a contents information extraction unit 200, a recording reservation unit 210, and a recording execution unit 220.

First of all, explanation will be made on the contents information extraction unit 200. The contents information extraction unit 200 comprises an analyzed motion video input unit 201, a telop area extraction unit 202, a character extraction unit 203, a character recognition processing unit 204, and a (broadcast) program information extraction unit 205. Also, the contents information extraction unit 200 is started, when the user instructs an analysis, when times reaches to that determined on a scheduler not shown in the figure, when detecting the motion video data not yet analyzed within the program information, or when the recording operation is started. Those cases for starting can be combined with, arbitrarily. Or also, the user may determine them.

The analyzed motion video input unit 201 inputs the motion video data stored in the secondary memory 103. Also, in case where the analyzed motion video input unit 201 be started when the recording operation is started, it may be so structured that a recording data input unit 221 may input the recording motion video data, which will be mentioned later.

The telop area extraction unit 202 specifies pixel areas to be determined on a telop, from the motion video data inputted within the analyzed motion video input unit 201, and then generates cut images consisted of the pixel data, and also specifies a time when the telop appears thereof and a time when the telop disappears. In case where the processing time and the amount of available memory is limited, contents information extraction unit 200 does not generate the cut image of the pixel area, generate coordinate information on the pixel areas. As the method, for specifying the pixel areas determined on a telop, the conventional method may be applied, which is already known by, for example, Japanese Patent Laying-Open No. Hei 9-322173 (1997), Japanese Patent Laying-Open No. Hei 10-154148 (1998), or Japanese Patent Laying-Open No. 2001-285716 (2001), etc. As the method, for specifying the time when the telop appears thereof and the time when the telop disappears, the conventional method may be applied, which is already known by, for example, David Crandall, Sameer Antani, Rangachar Kasturi, “Extraction of special effects caption text events from digital video”, IJDAR (2003) 5: 138-157, etc.

The character extraction unit 203 specifies pixel areas to be determined on the character(s), for the image cutted the telop area extraction unit 202, and then generates the cut image consisted of character pixel areas. As the method, for specifying the pixel areas to be determined on the character, may be the conventional method, which is already known by, for example, Japanese Patent Laying-Open No. 2002-279433 (2001), Japanese Patent Laying-Open No. 2006-59124 (2001), etc.

The character recognition processing unit 204 recognizes characters, for the image cutted the character extraction unit 203, and then and then obtains candidate character strings. As the character recognition processing therein can uses the character recognition program within an OCR (Optical Character Reader) apparatus.

Also, any of the telop area extraction unit 202, the character extraction unit 203 and the character recognition processing unit 204 may be so constructed that data outputted by each can be used mutually, so as to increase accuracy of extraction or recognition. Any of them can be execute when the user instructs a recording reservation of a (broadcast) program shown on a program promotion. Also, In case where the processing time and the amount of memory is available, any of them can be execute at a predetermined time distance.

The program information extraction unit 205 determines on whether a (broadcast) program name or title and/or time information are included or not, in candidate character strings which are recognized within the character recognition processing unit 204, with using the electronic program guide, which is obtained within the broadcast data input device 106 or the network data sent/received device 107. In case when determining that they are included, then the program name or title and/or the time information, etc., are extracted as the program information, and they are stored into the secondary memory 103 with the appearing time and the disappearing time of the telop to include character strings of program information. At the same time, the program information extraction unit 205 can calculates a reliability of extracted program information, and if the reliability is smaller than a predetermined condition (for example, a threshold value), then the program information extraction unit 205 can extract plural program information as candidates, and store into the secondary memory 103, and display the candidates on display device 104, it is possible for the user to select a right program information. Also, if the reliability is larger than the predetermined condition (for example, the threshold value), the program information extraction unit 205 can extract only one of some candidates of extracted program information, and store into the secondary memory 103. The reliability is set to, for example, “Emax” when the program information extraction unit 205 determines that both the program name and the time information are included, “Emin (<Emax)” when the program information extraction unit 205 determines that both are not included, and between “Emax” and “Emin” when the program information extraction unit 205 determines that only the time information or the program name is included. Further, to the reliability of program information mentioned above may be added a degree of reliability of candidate character strings or a probability of appearance of the program information for each position.

Also, the contents information extraction unit 200 may obtain the candidate character strings with using an speech recognition processing unit in the place of the telop area extraction unit 202, the character extraction unit 203 and the character recognition processing unit 204. Or, program information extract unit 205 can input a combination of candidate character strings which are obtained with using the telop area extraction unit 202, the character extraction unit 203 and the character recognition processing unit 204, and candidate character strings which is recognized with using the speech recognition processing unit. Or, program information extraction unit 205 can input meta data, which is distributed through the digital broadcast and/or is downloaded from Web.

Next, explanation will be made on a recording reservation unit 210. The recording reservation unit 210 comprises a reserved program selection unit 211, an automatic recoding condition acquiring unit 212, and a recording reservation setting unit 213. This recording reservation unit 210 is started, in case when the user watches the motion video data and a program information generated by contents information extraction unit 200 exist in the recording and playing apparatus, or when the user transmits an instruction for recording reservation of a program shown on a program promotion through the input device 105.

The reserved program selection unit 211 inputs a program information that is extracted within the contents information extraction unit 200, generates display data of said program information and display data for receiving or accepting the selection on recording reservation of said broadcast program, and sends above-mentioned two (2) display data to the display device 104, so as to be displayed on the display device 104, accepts the selection between “Yes” and “No” of the recording reservation from the user. When the recording reservation is selected through the input device 105, the reserved program selection unit 211 outputs said program information to the recording reservation setting unit 213, which will be mentioned later.

Examples of the recording reservation confirmation screen will be shown in FIGS. 3, 4, 5 and 6, when only one (1) broadcast program is promoted. However, it can be achieved if a plural number of broadcast programs are promoted or advertised.

FIG. 3 shows an example of displaying display data 302 of program information extracted within the contents information extraction unit 200, and display data 303 to be used by the selection on the recording reservation, on the display device 104, at the position other than the program promotion telop 301 within the motion video. In this manner, by bringing the program promotion telop 301 and the display data 302 of said program information to be visible for the user, it is possible to notice an error to the user and prevent the incorrect recoding reservation, when the program information which is extracted within the contents information extraction is an error, unit 200. The example shown in FIG. 3 can be applied into a case where a candidate of the program information is only one (1), and also the reliability of the program information, which is calculated within the program information extraction unit 205, is smaller than the predetermined condition. Also, in particular, when for playing the moving video data and the telop 301 disappears, the display data 302 can be remained. With this, there can be obtained an advantage, i.e., it can be seen on what broadcast program the user is going to reserve recording.

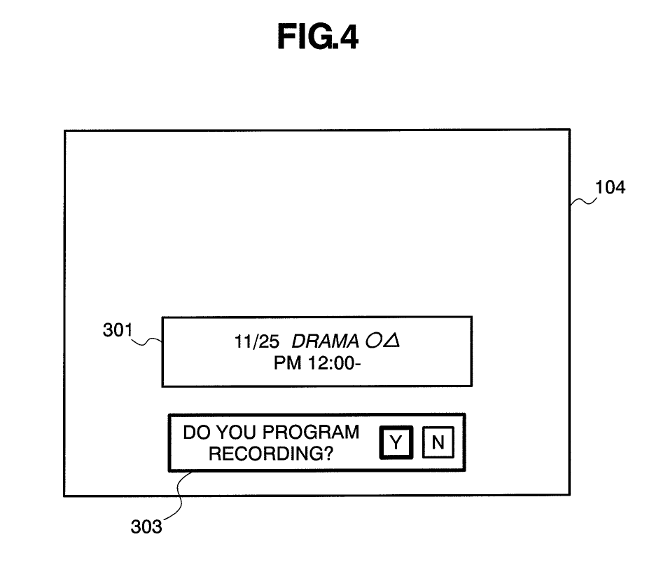

FIG. 4 shows an example of displaying the display data 303 to confirm the selection on the recording reservation, on the display device 104, at the position other than the program promotion telop 301 within the moving video data. In comparison with the example shown in FIG. 3, a ratio of occupying on the screen is small since not showing the display data 302 thereon, but on the other hand, it is impossible for the user to see that the program information extracted within the program information extraction unit 205 is correct; therefore, this have to be applied, selectively, by changing when the reliability calculated within the program information extraction unit 205 is larger than the predetermined threshold value.

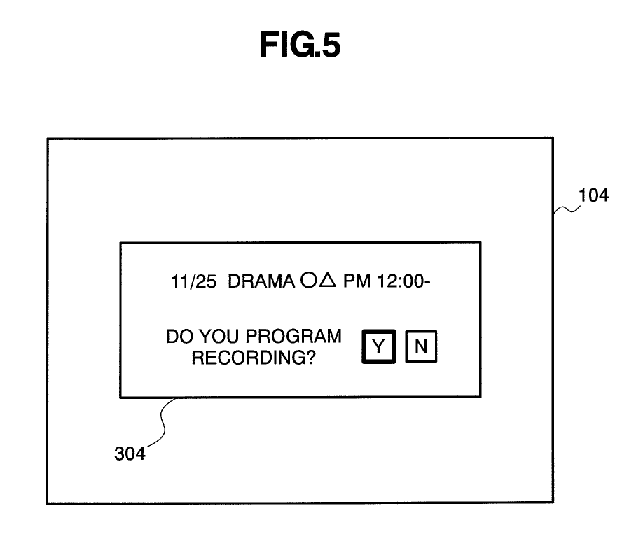

FIG. 5 shows an example of displaying the display data 304, which is obtained by composing the display data 302 of the program information extracted within the contents information extraction unit 200 and the display data 303 to confirm the selection on the recording reservation, on the display device 104, at the position where the program promotion telop 301 appears within the moving video data. With the example shown in FIG. 5, it is possible to prevent the user from overlooking the recording reservation screen of the program shown by the program promotion, in which the user is interested, by applying it into the case when the extracted program is same to the broadcast program, upon which the user already recorded, or which coincides with the category of the broadcast program, which is already set up by the user, or which coincides with the program category, which the user record at most.

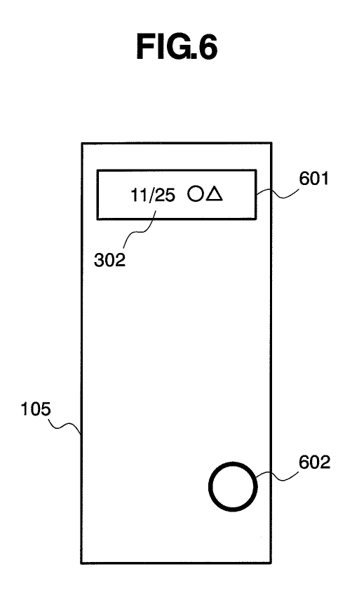

FIG. 6 shows an example of displaying the display data 302 of the program information extracted within the contents information extraction unit 200, on the display screen 601 provided in the input device 105. With the example shown in FIG. 6, it is possible to confirm the program promotion and the program information within the moving video data, at the same time, if a space is insufficient for displaying the display data 302 on the display device 104, by applying it into the case, for example, when a total size of some telop areas, which are extracted within the telop area extraction unit 202 is equal to or greater than a predetermined threshold value.

In any case of those FIGS. 3 to 6, all of the display data of the respective program information can be displayed when the candidates of the program information are plural.

Other than this example, it is also possible for the user to see the program promotion, easily, by displaying a program promotion decorated by image processing on the display device 104, for example, or for the user to reserve correctly recording of a program shown by a program promotion, by displaying all or a predetermined number of the program information to be said the candidates, on a playing motion video, in an order of the reliability thereof, when the program information extraction unit 205 extract some candidates of program information. It is also possible for the user to see the program promotion anytime after the program promotion is broadcasted, by storing the program information extracted within the program information extraction unit 205, on the main memory 102 or the secondary memory 103.

The automatic recoding condition acquiring unit 212 inputs the condition for automatically recording the broadcast program, which is stored in the secondary memory 103 (hereinafter, being called “automatic recording condition”), from an automatic recoding condition input unit 230, and then outputs the automatic recording condition to the recording reservation setting unit 213.

The recording reservation setting unit 213 determines on whether the recording and playing apparatus can record or not, upon the broadcast program, on which the selection of recording reservation is received or accepted within the reserved program selection unit 211. When the recording and playing apparatus can record, the recording reservation setting unit 213 generates recording reservation data of said broadcast program, and stores the recording reservation data onto a recording reservation table, and thereby output to a recording control unit 221, which will be mentioned later. In the structures thereof, the recording reservation data is constructed with, for example, a channel of the broadcast program to be recorded, a starting time of recording, and an ending time of recording. Also, for the broadcast program on which the selection of the recording reservation is not accepted within the reserved program selection unit 211, when the program information, which is extracted within the contents information extraction unit 200, matches with the automatic recording condition, which is obtained within the automatic recording condition acquiring unit 212, the recording reservation setting unit 213 generates the recording reservation data of said broadcasting data, and stores said recording reservation data onto the recording reservation table, and then output said recording reservation data to the recording control unit 221, which will be mentioned later.

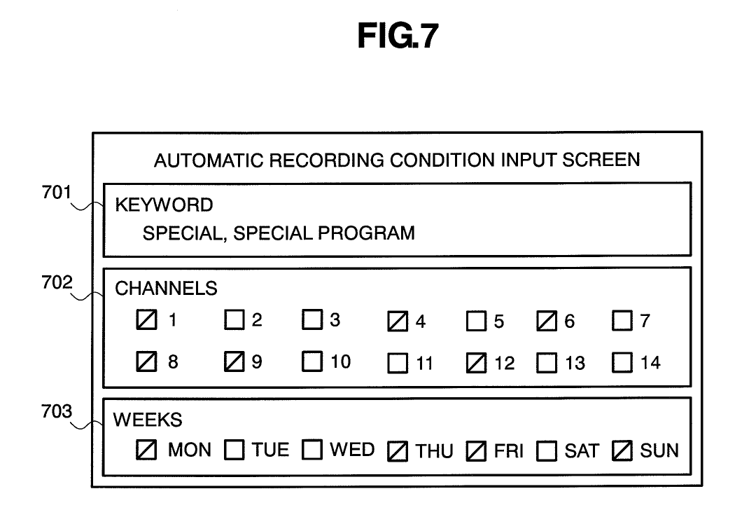

The automatic recoding condition input unit 230 generates a screen for accepting an input of the automatic recoding conditions, and then displays the generated screen on the display device 104, and then receives an input of the automatic recording conditions from the user. When receiving the input of the automatic recording condition from the user, The automatic recoding condition input unit 230 stores the automatic recording condition into the secondary memory 103. As the automatic recording condition accepting from the user, for example, there are used keywords, genres or categories (for example, a movie, a baseball, a documentary, etc.), channels, time zones (for example, midnight, weeks, etc.) or the like. An example of the screen for receiving the input of the automatic recording condition is shown in FIG. 7. In the example shown in FIG. 7, the screen for receiving the input of the automatic recoding condition is comprised with a keyword condition acquiring screen 701, a channel condition acquiring screen 702, and a week condition acquiring screen 703.

Lastly, explanation will be given on the recording execution unit 220. The recording execution unit 220 is constructed with the recording control unit 221, a recoding data input unit 222, and a memory control unit 223.

The recording control unit 221 inputs the moving video data into the main memory 102, through the recording data input unit 222, which will be mentioned later, from the broadcast data input device 106 or the network data sent/received device 107, and then instruct the memory control unit 223 to store the moving video data, which will be mentioned later, when the present time reaches to the starting time of recoding, which is described in any the recoding reservation data stored on the recording program table inputted from the recording program setting unit 213.

When inputting the moving video data through the broadcast data input device 106, first of all, the recording control unit 221 sets the channel described in the recording reservation data or the channel that the user sets up through input device 105, to the broadcast data input device 106 through the recoding data input unit 222, which will be mentioned later. Next, the recording control unit 221 instruct the recoding data input unit 222 to store the moving video data.

When inputting the moving video data through the network data sent/received device 107, the recording control unit 221 sets URI described in the recording reservation data or URI that the user sets up through the input device 105, to the network data sent/received device 107 through the recording data input unit 222, which will be mentioned later. Next, the recording control unit 221 instruct the recoding data input unit 222 to store the moving video data.

The recording data input unit 222 is started by means of the recoding control unit 221, and it inputs the moving video data of a recording target from the broadcast data obtain unit 106 or the network data sent/received device 107. When inputting the moving video data from the broadcast data obtain unit 106, the recording data input unit 222 obtains the moving video data, which is broadcasted through the channel setted within the recording control unit 221, stores it into the main memory 102. When the broadcast is an analog one, then the recording data input unit 222 converts the moving video data into digital data, stores it into the main memory 102. When the broadcast is digital one, then the recording data input unit 222 stores the moving video data into the main memory 102 as it is. When inputting the moving video data from the network data sent/received device 107, the recording data input unit 222 obtains the moving video data through the network, with an instruction of the recording control unit 221, and stores it into the main memory 102.

The memory control unit 223 memorizes the moving video data, which is inputted from the recording data input unit 222 and stored into the main memory unit 102, with the instruction from the recording control unit 221, into the secondary memory unit 103. In this instance, the memory control unit 223 compresses the moving video data with a method, such as, MPEG, etc., and then stores into the secondary memory unit 103.

Next, explanation will be made on a processing flow of each function block of the recording and playing apparatus.

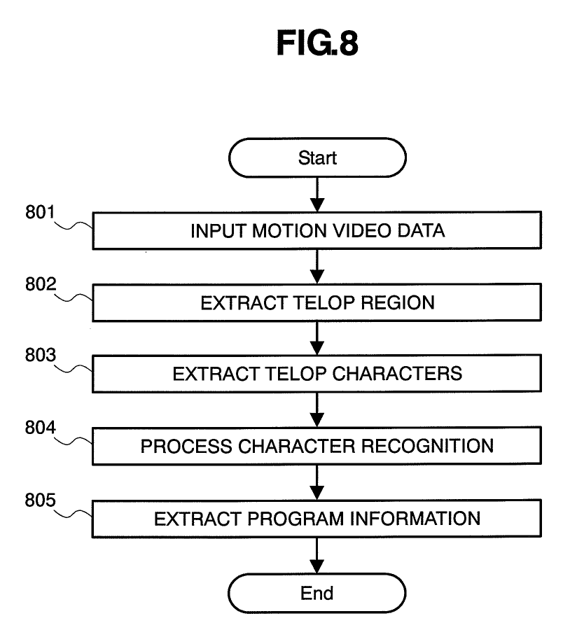

FIG. 8 shows a flowchart of processes for extracting the program information of the program promotion within the contents information extraction unit 200 of the recording and playing apparatus.

For the contents information extraction unit 200, the analyzed motion video input unit 201 inputs the motion video data which is stored in the secondary memory 103 (step 801). This process can be executed, not restricting to the motion video data stored in the secondary memory 103, but also on the motion video data, which is inputted from the broadcast data input unit 106 or the network data sent/received device 107.

The telop area extraction unit 202 specifies pixel areas to be determined on a telop from the motion video data inputted in the step 801, and then generates the cut images consisted of the pixel data and the appearing time and disappearing time of said telop (step 802).

The character extraction unit 203 specifies pixel areas to be determined on the character(s), for the image cutted in the step 802, and generates the cut image consisted of character pixel areas (step 803).

The character recognition processing unit 204 recognizes characters for the image cutted in the step 803, and obtains candidate character strings (step 804).

The program information extraction unit 205 determines on whether a (broadcast) program name or title and/or broadcasted time information in electronic program guide stored in the secondary memory 103 are included or not, in candidate character strings which are recognized within the character recognition processing unit 204, and extracts the program name or title and/or the broadcasted time information, etc., as the program information, when it is included. The data structure of the program information is comprised; a program name, a broadcasting time, a starting time, and an ending time.

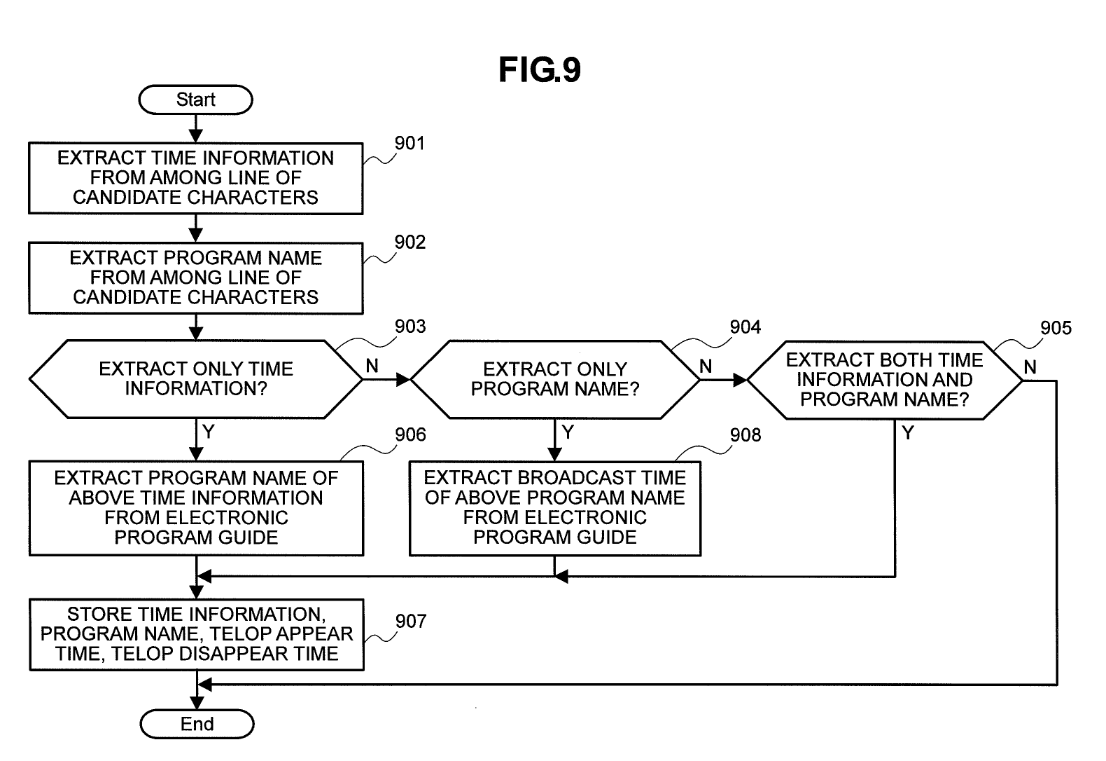

Details of the method for extracting the broadcast program (step 805) will be explained, by referring to the flowchart shown in FIG. 9.

In extracting method (step 805) of the program information shown in FIG. 9, the program information extraction unit 205 searches and extracts the time information from among candidate character strings (step 901).

By referring to the candidate character strings and the broadcast names on the electronic program guide during a predetermined period, which are stored in the secondary memory 103, the program information extraction unit 205 extracts said program name from among the candidate character strings (step 902).

In case when only the time information can be extracted on a result of the steps 901 and 902 (“Y” in step 903), then the program information extraction unit 205 extracts the program name which will be broadcasted at that time, from the electronic program guide, by considering said time information to be the broadcast time of that program (step 906).

The program information extraction unit 205 stores the extracted program name, broadcast time, an appearance time and the disappearance time of the telop to include character strings of said program information that is extracted within the this telop area extraction unit 202 therein, into the secondary memory 103 (step 907), and the present process is ended.

In case when only the program name can be extracted on a result of the steps 901 and 902 (“Y” in step 904), then the program information extraction unit 205 searches said program name from the electronic program guide, and extracts the time when the program of said program name will be broadcasted (step 908).

The program information extraction unit 205 stores the extracted program name, broadcast time, appearing time and the disappearing time of the telop to including character strings of said program information that is extracted within the this telop area extraction unit 202 therein, into the secondary memory 103 (step 907), and the present process is ended.

In case when both the time information and the program name can be extracted on a result of the steps 901 and 902 (“Y” in step 905), then the program information extraction unit 205 stores the extracted program name, broadcast time, appearing time and the disappearing time of the telop to include character strings of said program information that is extracted within the this telop area extraction unit 202 therein, into the secondary memory 103 (step 907), and the present process is ended.

In case when the time information and the program name fails to extract on a result of the steps 901 and 902 (“N” in step 905), then the present process is ended.

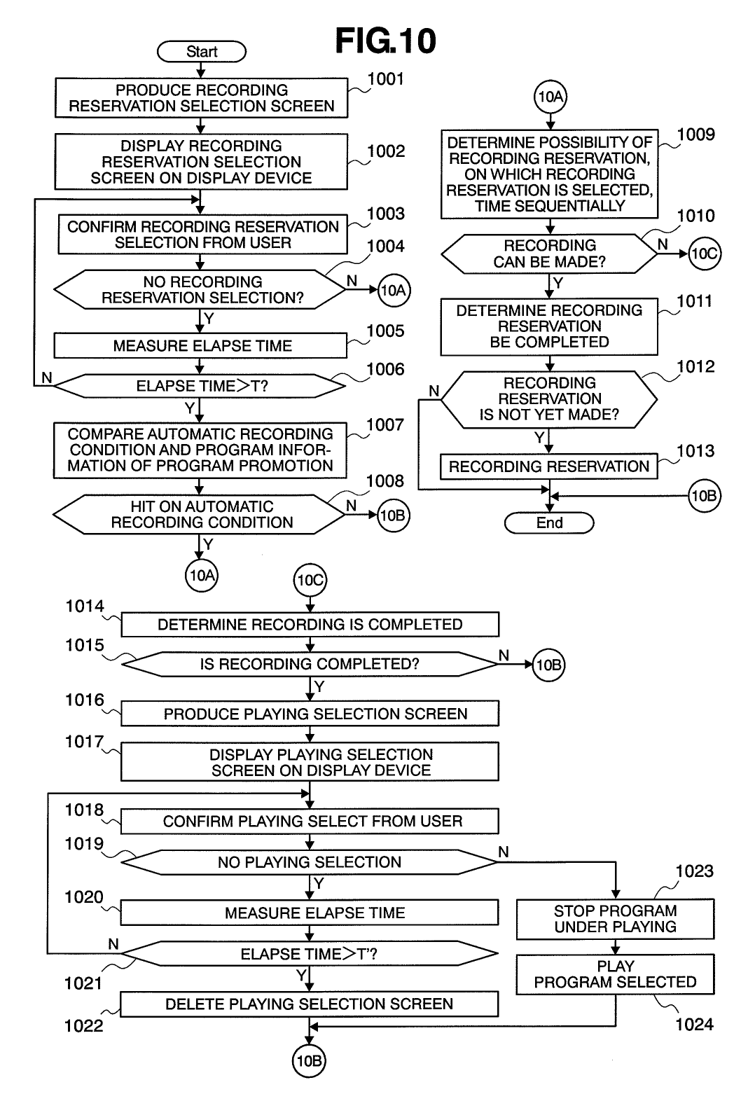

FIG. 10 shows a flowchart of the processes within the recording program unit 210 in the recording and playing apparatus. This processes will be executed upon after that the program information can be extracted within the contents information extraction unit 200, with an aid of the processing shown in FIGS. 8 and 9.

In the recording program unit 210, the reserved program selection unit 211 generates recording reservation selection screen data comprised display data of the program information and display data for receiving or accepting the selection on recording reservation of said broadcast program (step 1001), and it sends said screen data to the display device 104 or the input device 105, so as to be displayed the program selection screen, the examples of which are shown in FIGS. 3 to 6 (step 1002).

The reserved program selection unit 211 confirms the existence or nonexistence of the recording reservation selection from the user (step 1003). In case where the user selects on the recording reservation (“N” in step 1004), and when “Yes” is selected on the display data 303 shown in FIG. 3, for example, the process moves to 10A in FIG. 10. When the user does not select on the recording reservation (“Y” in step 1004), the reserved program selection unit 211 measures execution time of the step 1002 (step 1005). When the user selects not to reserve the recording (for example, “N” is selected on the display data 303 shown in FIG. 3), then the process is ended (End).

In case when that said execution time is less than a certain time “T” (seconds, minutes, and hours) (“N” in step 1006), the reserved program selection unit 211 execute the step 1003. The time “T” may be fixed or variable.

If execution time is more than the time “T” (“Y” in step 1006), the reserved program selection unit 211 compares between the automatic recording condition, which was explained by referring to FIG. 7, etc., and the program information shown by the program promotion, which is extracted within the contents information extraction unit 200 (step 1007). As a result, if the program information coincides with the automatic recording condition (“Y” in step 1008), then the process moves to 10A shown in FIG. 10. The coincidence should not be limited to the complete coincidence, but it may be terminology including a partial coincidence and an inclusion, etc. If the program information does not coincide with the automatic recording condition (“N” in step 1008), the present process is ended (End).

Although there can be considered a method of reserving record of all the broadcast programs, which coincide with the automatic recording condition, but according to the present method, by reserving record of upon the program, which is shown by program promotion and coincide the automatic recording condition, it is possible to achieve the automatic recording much more appropriate. This is because, in general, a producer also pays efforts and powers onto creation of the broadcast program promotion, and a degree of attention of the watchers also rises up, and therefore it is possible to achieve the automatic recording on such the program, and further fitting to the user's liking.

Explanation will be made on the processes starting from 10A in FIG. 10. the reserved program selection unit 211 compares between the starting time of program and the preset time of the program information, upon which is selected on the recording reservation in the step 1004, or which coincides with the automatic recording condition in the step 1008, and determines that recording is whether possible or impossible temporally (step 1009).

The reserved program selection unit 211 determines possibility of recording on the condition that the starting time of that program is a certain time “M” (seconds, minutes, and hours) whether past or before from the present time. This is because, for example, when extracting the program information from the program promotion for a while after recording, then there is a possibility that the program was already gone off thereof.

Further, the reserved program selection unit 211 can compare, simply between the starting time and the present time, however since it also takes a time for start of recording, therefore it is preferable to provided the certain time “M”. The time “M” can be fixed depending on the apparatus, or can be variable for the user, or can be variable depending on the surrounding where the apparatus is provided (i.e., a speed of broadcast and communication). Also, the time “M” may be a negative number. Thus, if it is possible to reserve a recording from the middle of the program, the reserved program selection unit 211 can execute on recording reservation. In this case, the time “M” is set to be variable upon basis of the time of the program (for example, if it is one (1) hour program, the recoding reservation may be allowed up to the time when elapsing 50 minutes (−50 minutes) from the starting time). In this case, the reserved program selection unit 211 confirms playing the program to the user, but not recording the program, and the reserved program selection unit 211 play the program when the user select the playback. Or, the reserved program selection unit 211 can compares not with the starting time, but with the ending time thereof.

As a result of the comparison, if the recording is impossible (“N” in step 1010), i.e., for example, when the program goes off, the process moves to 10C in FIG. 10.

As a result of the comparison, if the recording is possible (“Y” in step 1010), i.e., for example, when the program will starts hereinafter, the reserved program selection unit 211 determines on whether the broadcast program was already recorded or not (step 1011), by checking that the program information is included within the entire recording reservation data in the recording reservation table. If the broadcast program is not reserved the recording (“Y” in step 1012), the reserved program selection unit 211 generates recording reservation data for that broadcast program, and store said recoding reservation data on the recording program table, so as to set up the recording reservation for that broadcast program (step 1013). If the broadcast program is reserved the recording (“N” in step 1012), the present process is ended (End).

Next, explanation will be made on the processes after 10C, in case where recording is impossible on the broadcast program, upon which the recording reservation is selected.

By searching on the motion video data of the program in the secondary memory 103, the reserved program selection unit 211 determines on whether the broadcast program was already recorded or not (step 1014). Because of searching on the motion video data of the program in the secondary memory 103, the case where the reserved program selection unit 211 determined that recoding was impossible in the step 1010, is included the case where the broadcast program goes off but was already recorded. As a result of the step 1014, if not yet recorded (“N” in step 1015), then the present process is ended.

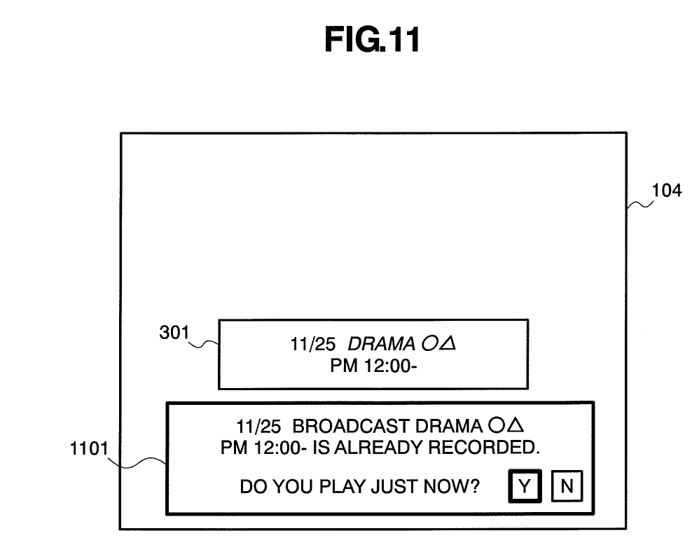

If already recorded (“Y” in step 1015), the reserved program selection unit 211 generates the playing selection screen data to select on whether playing or not the broadcast program by the user (step 1016), and sends this playing selection screen data to the display device 104, to display the playing selection screen on the display device 104 (step 1017). An example of display is shown in FIG. 11.

The playing selection screen shown in FIG. 11 has a program promotion telop 301 within the motion video data, and display data 1101 for selection of the programs, which are already recorded. Instead of not displaying the playing selection screen, the reserved program selection unit 211 can show a message for indicating that the program shown by the program promoted is already recorded.

Next, the reserved program selection unit 211 confirms on whether the playing selection from the user exist or not (step 1018), and when it is not selected on the program by the user (“N” in step 1019), the reserved program selection unit 211 measures the execution time on the step 1002 (step 1020). In case where the execution time is less than a predetermined time “T′” (“N” in step 1021), the reserved program selection unit 211 executes the step 1018. When the execution time is more than the time “T′” (“Y” in step 1021), the playing selection screen is off (step 1022), and the present process is ended (End). Also when selection is playing (select “N” on the display screen 1101), the reserved program selection unit 211 executes the step 1022.

In case when playing is selected by the user (“N” in the step 1019), the recording and playing apparatus stopped the playing program (step 1023), while the recording and playing apparatus play the program selected (step 1024), and then the present process is ended (End).

Although showing the example that the step 1015 is executed after executing the step 1010, it can be executed before that. Or, only either one of them can be applied.

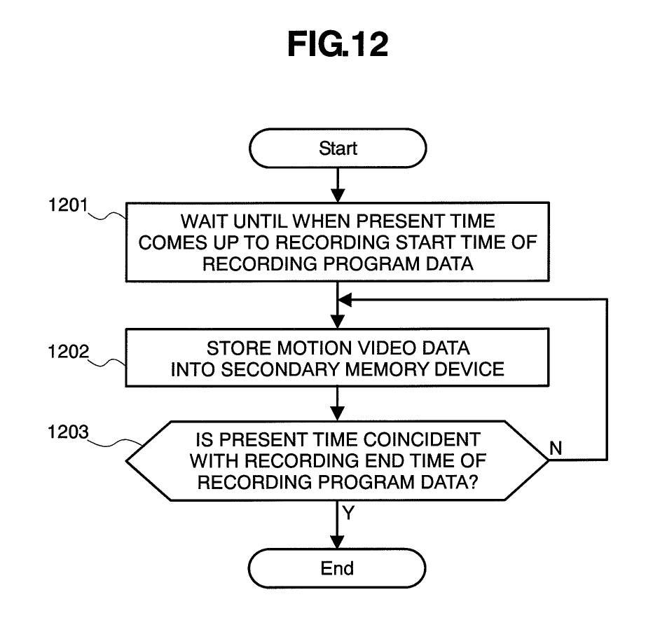

FIG. 12 shows a flowchart of the processes, within the recording execution unit 220. This recording execution unit 220 waits until when the present times comes to the recording start time, which is described in the recording program data (step 1201). When reaching to the recording start time, the recording control unit 221 stores the motion video data, from The broadcast data input device 106 or the network data sent/received device 107 through the recording data input unit 222, into the main memory 102, and it starts the memory control unit 223, and thereby the memory control unit 223 stores the motion video data, which is stored in the main memory 102, into the secondary memory 103 (step 1201). When the present time does not reach to the recording end time, which is described in the recording program data (step 1203), then the present process is ended.

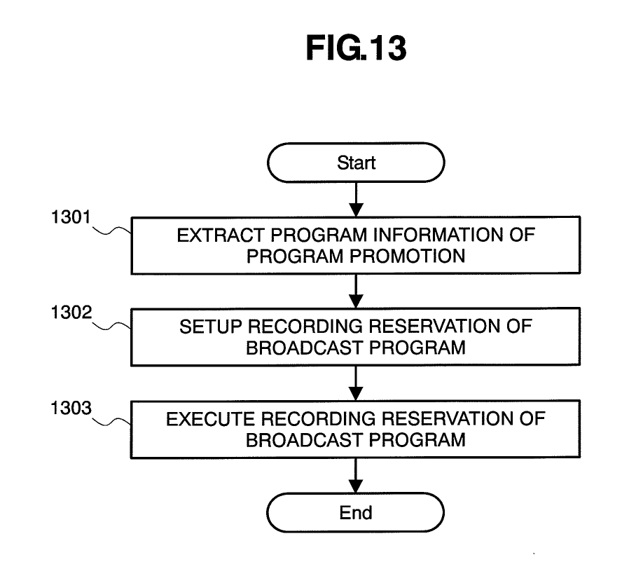

FIG. 13 shows a flowchart of the processes for reserving recording of the broadcast program of the program promotion. First of all, when the user instructs an analysis, when times reaches to that determined on a scheduler not shown in the figure, when detecting the motion video data not yet analyzed within the program information, or when the recording operation is started. Those cases for starting can be combined with, arbitrarily. Or also, the user may determine them, then the contents information extraction unit 200 extracts information of the program shown by of the program promotion from the motion video data (step 1301). In case when the user is playing motion video data, and also when the process of the contents information extraction unit 200 for that motion video data is completed, or when the user sends the instruction of displaying the program promotion information through the input device 105, the recording reservation unit 210 generates a recording reservation data and store it on the recording reservation table, to setup the recording reservation of the program shown by the program promotion (step 1302). Next, the recording execution unit 220 executes the recording upon basis of the recording reservation data on the recording reservation table (step 1303).

With this, there is provided the recording and playing apparatus for obtaining easily the recording reservation data from the promotion of the broadcast program, which is played on the during the broadcast program being broadcasted or the recorded.

### Embodiment 2

In the embodiment 1, the explanation was made on the example of obtaining the program data from the motion video data, thereby reserving the recording thereon. In an embodiment 2, the recording and playing apparatus extracts not on the program distributed during a predetermined time (rather than distributed, but the user obtain), but the contents data on the network (hereinafter, being called “network contents information”, such as, URI, etc.), and thereby obtaining the contents.

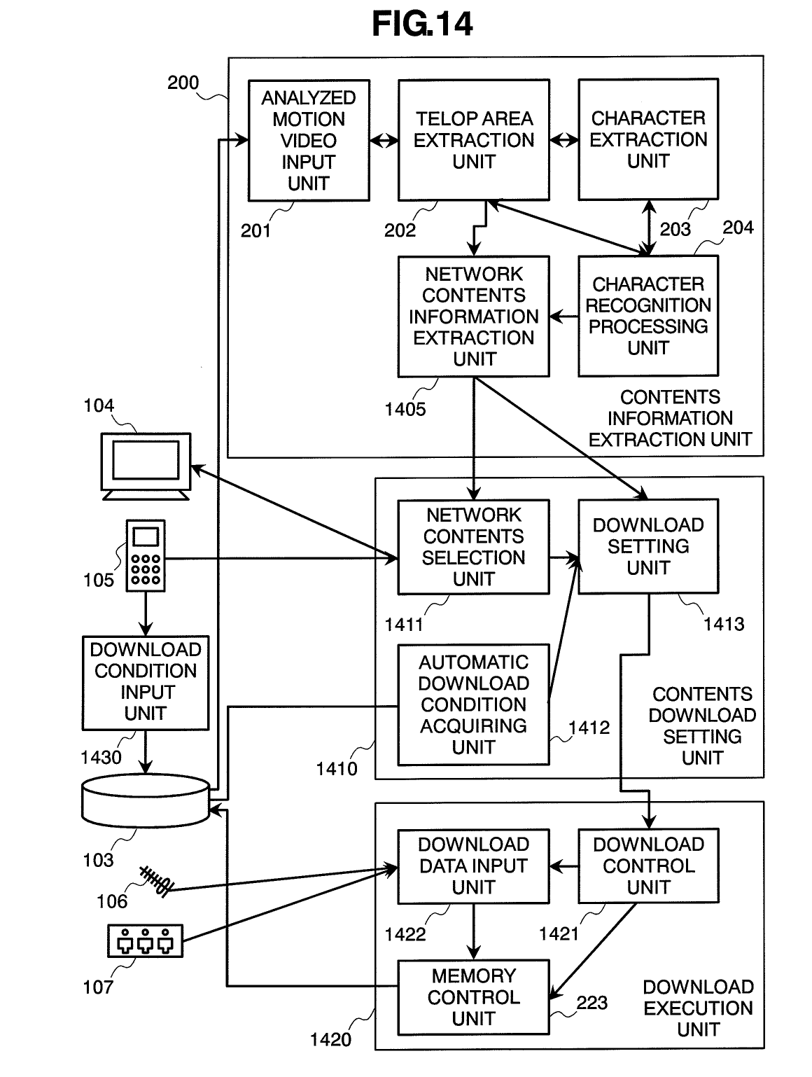

FIG. 14 is a function block diagram of the recording and playing apparatus, according to the embodiment 2. A part or the entire of the function blocks may be implemented with software which is stored within the main memory 102 or the secondary memory 103 shown in FIG. 2, to be executed by the CPU 101. Or it may be implemented with hardware. Hereinafter, as an example of this, explanation will assume that the entire of those function blocks are software programs, which are executed by the CPU 101.

The function blocks of the recording and playing apparatus comprises the following function blocks, i.e., a contents information extraction unit 200, a contents download setting unit 1410, and a download execution unit 1420. First of all, explanation will be made on the contents information extraction unit 200.

The contents information extraction unit 200 comprises the analysis motion video data input unit 201, the telop area extraction unit 202, the character extraction unit 203, the character recognition processing unit 204, which are shown in the embodiment 1, and a network contents information extraction unit 1405.

The network contents information extraction unit 1405 determines on whether a keyword is included or not, such as, “http://” or “htts://”, etc., used as URI, in the candidate character strings which are recognized within the character recognition processing unit 204. In case when determining that they are included, then the network contents information extraction unit 1405 extracts characters starting from said keyword up to a space, stores it into the secondary memory unit 103. The network contents information extraction unit 1405 calculates a reliability of extracted network contents information, and if the reliability is smaller than a predetermined condition (for example, a threshold value), then the network contents information extraction unit 1405 can extract plural network contents information as candidates, and store into the secondary memory 103, and display the candidates on display device 104, it is possible for the user to select a right network contents information. Also, if the reliability is larger than the predetermined condition (for example, the threshold value), the network contents information extraction unit 1405 can extract only one of some candidates of extracted network contents information, and store into the secondary memory 103. With this, i.e., showing the plural number of candidates to the user, it is possible for the user to select the right one. Also, in case where the degree of conviction is larger than the predetermined condition (for example, the threshold value), only one of the network contents information is selected to be the candidate, and is stored in the secondary memory 103. The reliability of the network contents information is set to a rate of extraction of URI keyword characters, for example. Further, to the reliability may be added a degree of reliability of the candidate character strings, or a probability of appearance of the network contents information for each position.

Next, explanation will be made on the contents download setting unit 1410.

The contents download setting unit 1410 comprises a network contents selection unit 1411, an automatic download condition acquiring unit 1412, and a download setting unit 1413.

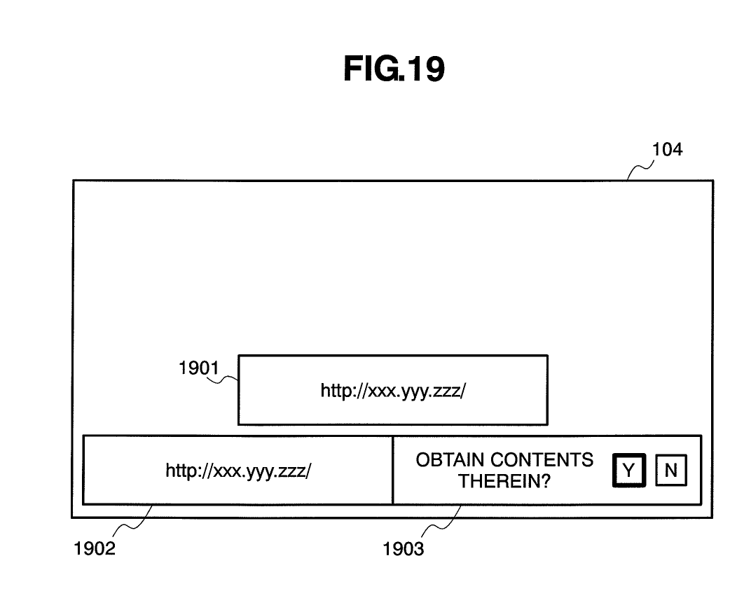

The network contents selection unit 1411 inputs a network contents information, which is extracted within the network contents information extraction unit 1405, generates display data of that network contents information and display data for receiving the selection on download of that network contents, and sends the display data of that network contents information and the display data for receiving the selection of download to the display device 104, and accepts the selection between “Yes” and “No” of obtaining the network contents from the user. In case where the download is selected through the input device 105, the network contents selection unit 1411 outputs said network contents information to the download setting unit 1413, which will be mentioned later. An example of the network contents selection screen will be shown in FIG. 19.

FIG. 19 shows an example of displaying display data 1902 of the network contents information, which is extracted within the network contents information extraction unit 1405, and display data 1903 to be used by selection on obtaining the network contents, on the display device 104.

The automatic download condition acquiring unit 1412 inputs the condition for obtaining the network contents, automatically, which is inputted and stored in the secondary memory 103 by a download condition input unit 1430, which will be motioned later, and outputs an automatic download condition to the download setting unit 1413.

The download setting unit 1413 outputs the URI of the contents, on which the selection of download is received within the network contents selection unit 1411, to a download control unit 1421. Also, when no selection of download is received within the network contents select unit 1411, the download setting unit 1413 outputs the URI of said contents to the download control unit 1421, when the URI of said contents, which is extracted within the contents information extraction unit 200, matches with the automatic download condition, which is obtained within the automatic download condition acquiring unit 1412.

The download condition input unit 1430 generates a screen for receiving an input of automatic download conditions, and then displays the screen generated on the display device 104, thereby receives an input of the automatic recording condition from the user. When receiving the input of the automatic download conditions from the user, The download condition input unit 1430 storeds the automatic download condition into the secondary memory 103.

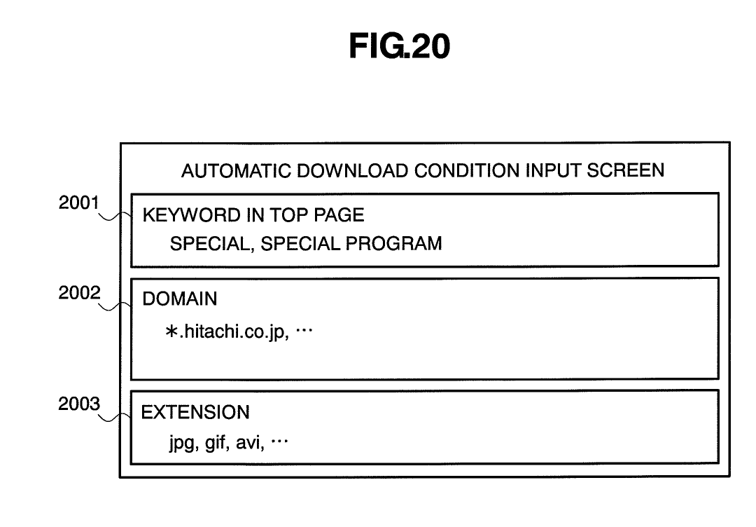

As the automatic download condition to be received from the user may be used, such as, a keyword, a domain, or an extension of contents, which is included within a top page, for example. An example of the screen for receiving the input of the automatic download condition is shown in FIG. 20. In the example shown in FIG. 20, the screen for receiving the input of the automatic recording condition is comprised with a screen 2001 for setting up a keyword included within the top page, a screen 2002 for setting up the condition of the domain, and a screen 2003 for setting up the condition of the extension.

Next, explanation will be made on the download execution unit 1420.

The download execution unit 1420 is constructed with the memory control unit 223, which was explained in the embodiment 1, a download control unit 1421, and a download data input unit 1422.

The download control unit 1421 sets up said URI in the network data sent/received device 107 through the a download data input unit 1422, when receiving the URI information from the download setting unit 1413, or when the URI is set up through the input device 105 from the user. Next, the download control unit 1421 inputs the contents of said URI into the main memory 102, and stores into the secondary memory 103 by the memory control unit 223.

The download data input unit 1422 is started by the download control unit 1421, obtains the target contents by downloading from the network data sent/received device 107, and stores it into the main memory 102.

Next, explanation will be made on a process flow of each function block of the recording and playing apparatus.

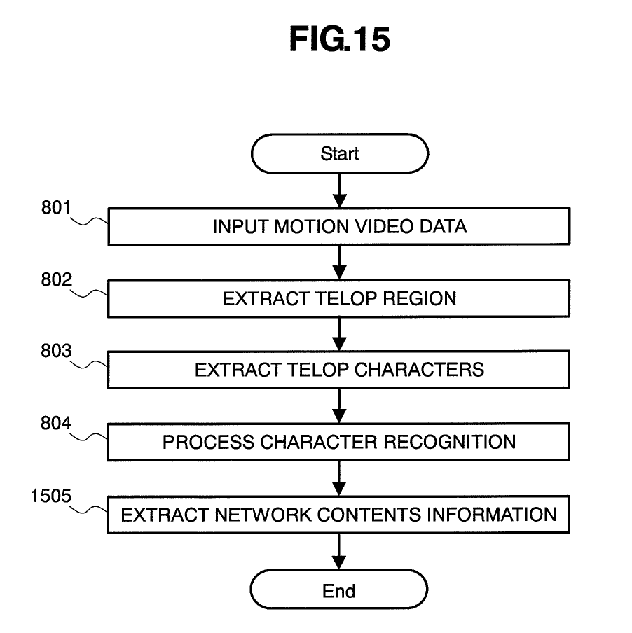

FIG. 15 shows a flowchart of the processes within the contents information extraction unit 200 in the recording and playing apparatus.

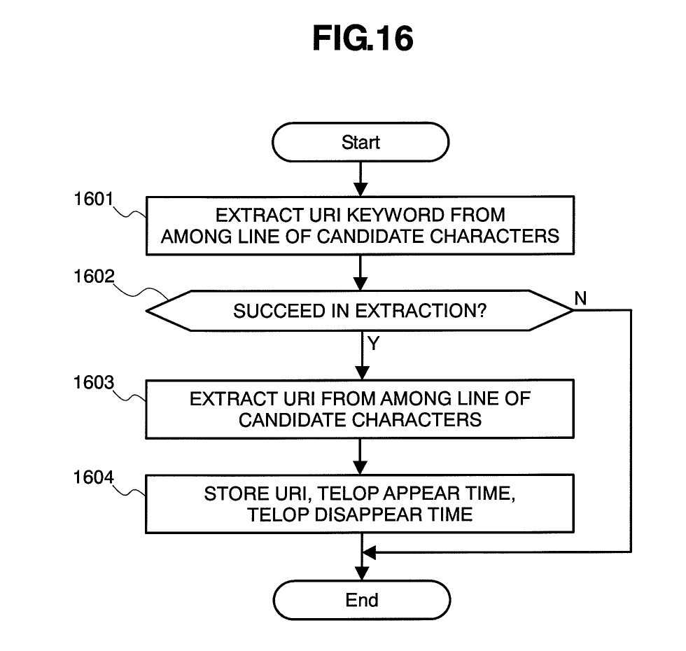

This contents information extraction unit 200 processes similar to those shown in FIG. 8, from the step 801 to the step 804, and next, the network contents information extraction unit 1405 determines on whether the URIs are included or not, in the candidate character strings, which are recognized within the character recognition processing unit 204, and extracts the URI, as the network contents information (step 1505), in case when it is included. The data structure of the network contents information is comprised with the URI, the starting time, and the ending time. The extracting method (step 1505) of the network contents information will be explained by referring to the flowchart shown in FIG. 16.

In the extracting method of the network contents information (step 1505), the network contents information extraction unit 1405 extract the URI keyword in among candidate character strings (step 1601). As a result of the step 1601, when the URI keyword is extracted (“Y” in step 1602), the network contents information extraction unit 1405 extract the characters from said URI keyword up to presence of a space as the URI (step 1603). the network contents information extraction unit 1405 stores the URI extracted, an appearance time and disappearance time of the telop to include character strings of said network contents information that is extracted within the this telop area extraction unit 202 therein, into the secondary memory 103 (step 1604), then the present process is ended. As a result of the step 1601, in case when the URI keyword fails to extract only the time information (“N” in step 1602), then the present process is stopped.

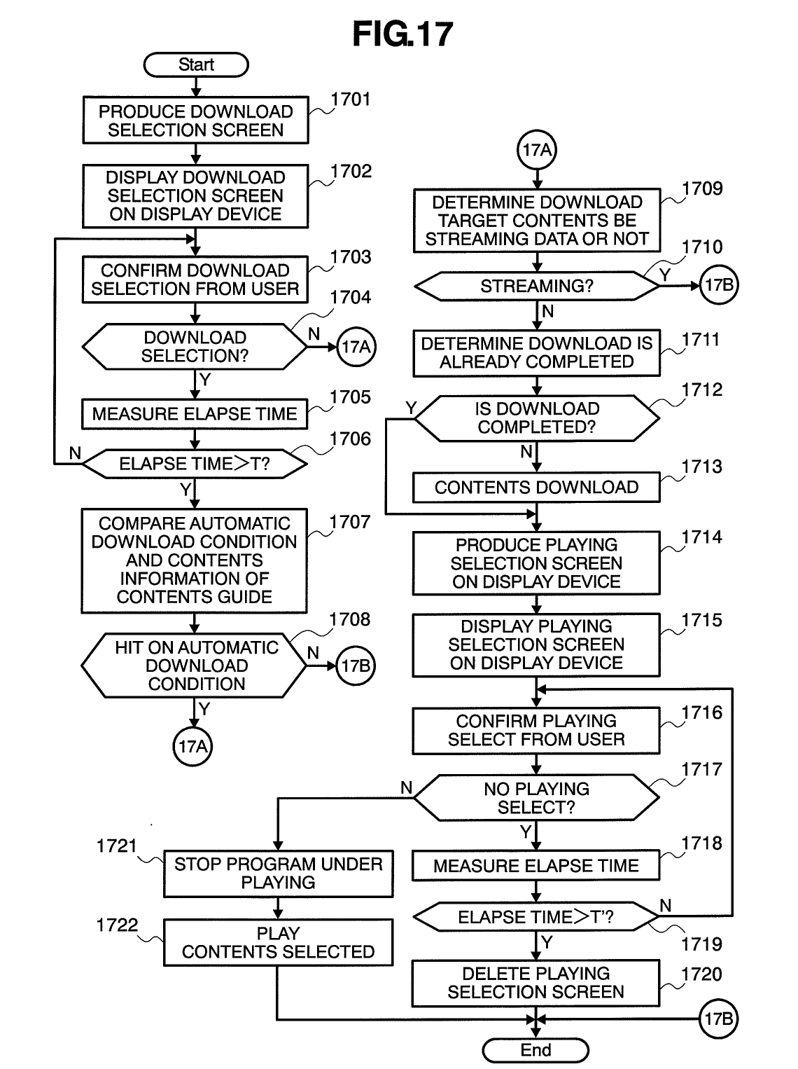

FIG. 17 is a flowchart of processing within the contents download setting unit 1410 in the recording and playing apparatus.

In this contents download setting unit 1410, a network contents selection unit 1411 generates the download selection screen data composing the display data of the contents information and the display data for receiving the download (step 1701), and sends the download selection screen data to the display device 104 or the input device 105, so as to be displayed the download select screen, an example of which is shown in FIG. 19 (step 1702).

The network contents selection unit 1411 confirms the present of the download selection from the user (step 1703). If the user selects on download (“N” in step 1704), for example, when “Yes” is selected on the display data shown in FIG. 19, the process moves to 17A shown in FIG. 17. If the user does not select on download (“Y” in step 1704), then the network contents selection unit 1411 measures execution time of the step 1702 (step 1705). When the user selects not to download on download selection screen (for example, select “N” on the display data 1903 shown in FIG. 19), then the process is ended (End).

In case when said execution time is less than the certain time “T” (seconds, minutes, and hours) (“N” in step 1706), then the network contents selection unit 1411 execute the step 1703. The time “T” may be fixed or variable.

When execution time is more than the time “T” (“Y” in step 1706), the network contents selection unit 1411 compares between the automatic download condition, which is explained in FIG. 20, etc., and strings within the URI of the network contents, which is extracted within the contents information extraction unit 200 or the top page of said URI (for example, “http://xxx.yyy.zzz/**/” or “http://xxx.yyy.zzz/**/” if the URI is “http://xxx.yyy.zzz/**/a.jpg) (step 1707). As a result of this comparison, if strings within the URI of the network contents coincides with the automatic download condition (“Y” in step 1708), the process moves to 17A shown in FIG. 17. However, the coincidence should not be limited to the complete coincidence, but it may be terminology including a partial coincidence and an inclusion, etc. If the program information does not coincide with the automatic recording condition (“N” in step 1708), the present process is ended (End).

Next, explanation will be given on the processes starting from 17A. First of all, by analyzing on said URI, the network contents selection unit 1411 determines whether the target download contents is streaming data or not (step 1709). As a result of the determination, if it is the streaming (“Y” in step 1710), then the present process is ended. If not the streaming (“N” in step 1710), by searching the data of contents from the secondary memory 103, the network contents selection unit 1411 determines that whether the download is already done or not on the network contents of the URI, which is described by the network contents information.

As a result of the search, if download is already completed (“Y” in step 1712), then the process moves to a step 1014. If the download is completed (“N” in step 1712), as the result of the search, the network contents selection unit 1411 outputs the URI to the download execution unit 1420, so as to execute the download execution unit 1420 (step 1713), and then the process moves to a step 1714.

Processes from the step 1714 to the step 1722 are similar to those from the step 1016 to the step 1024 shown in FIG. 10. However, in a step 1720 in FIG. 27, the network contents selection unit 1411 changes playing method depending upon type of the contents selected. For example, if the contents are video or text data, the recording and playing apparatus displays it on the display device 105. If the contents are motion video, the recording and playing apparatus play it.

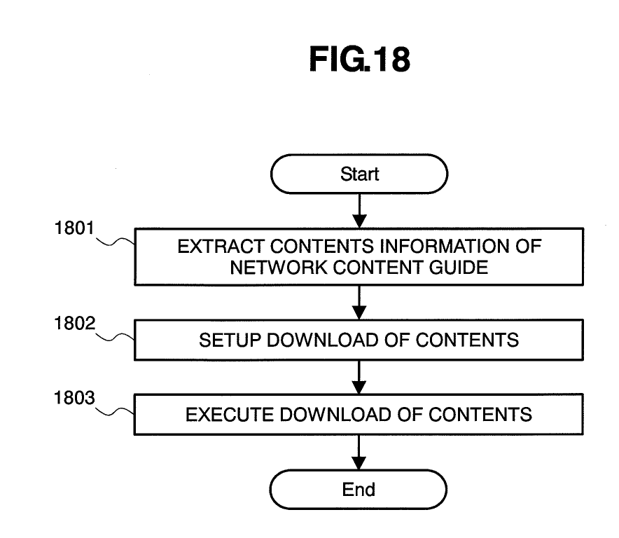

FIG. 18 shows a flowchart of processes for downloading the contents within the network contents guide. First of all, when the user instructs an analysis, when times reaches to that determined on a scheduler not shown in the figure, when detecting the motion video data not yet analyzed within the program information, or when the recording operation is started. Those cases for starting can be combined with, arbitrarily. Or also, the user may determine them, the contents information extraction unit 200 extracts the contents information of the network contents guide from motion video data (step 1801). In case when the user is playing the motion video data, and also when the process of the contents information extraction unit 220 is completed on said motion video data, or when the user sends an instruction of displaying the network contents information through the input device 105, then the contents download setting unit 1410 outputs the network contents information (herein, the URI) upon basis of selection of the contents download from the user and/or comparison to the automatic download condition, and thereby setting up the download (step 1802). Next, the download execute unit 1420 executes the download upon basis of the network contents information, which is outputted from the contents download setting unit 1410 (step 1803).

As was mentioned above, according to the above-mentioned embodiment, it is possible to obtain the recording reservation upon the contents guided by the contents guide, which is included in motion video data under reception or playback.

Also, the embodiments 1 and 2 may be combined with, or it is also possible to select and change the structures of steps of each of the embodiments mentioned above.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A video recording/playing apparatus, for recording or playing video data, comprising:
a contents information extraction unit, which is configured to extract content information displaying contents from video data under reception or playback thereof, differing from said video data;
a recording/playing control unit, which is configured to control recording or playing of a first contents corresponding to a first contents information, upon basis of said first contents information, which is extracted within said contents information extract unit.

2. The video recording/playing apparatus, as described in the claim 1, wherein said contents information extraction unit obtains the contents information by recognizing character on character video displayed on a screen of said video data and comparing to the contents guide information including a plural number of contents information therein.

3. The video recording/playing apparatus, as described in the claim 2, further comprising:
a contents selection unit, which is configured to display that the contents information is extracted within said first contents information extract unit, on said screen of said video data, together with character video indicating said first contents information, thereby confirming recording or playing of said first contents to a user.

4. The video recording/playing apparatus, as described in the claim 2, wherein a way of displaying the contents information obtained is changed depending upon a degree of character recognition by said contents information extraction unit or a reliability of comparison results.

5. The video recording/playing apparatus, as described in the claim 1, wherein said recording/playing control unit determines on whether said first contents extracted within said contents information extract unit is already recorded or not, and outputs that said first contents should be played or already recorded when determining that it is already recorded.

6. The video recording/playing apparatus, as described in the claim 1, wherein said contents are WEB contents.

7. The video recording/playing apparatus, as described in the claim 2, wherein said contents are WEB contents.

8. The video recording/playing apparatus, as described in the claim 3, wherein said contents are WEB contents.

9. The video recording/playing apparatus, as described in the claim 4, wherein said contents are WEB contents.

10. The video recording/playing apparatus, as described in the claim 5, wherein said contents are WEB contents.

11. The video recording/playing apparatus, as described in the claim 1, wherein said recording/playing control unit comprises a recording program unit, which is configured to determine on whether recording program can be made or not, upon said first contents.

12. The video recording/playing apparatus, as described in the claim 11, wherein said recording program unit determines on whether recording is programmable or not, upon basis of distribution time of said first contents information.

13. The video recording/playing apparatus, as described in the claim 11, wherein said recording program unit determines on whether said first contents are already recorded or not, when said first contents is determined to be un-programmable of recording, and outputs that said first contents should be played or already recorded when being decided to be already recorded.

14. The video recording/playing apparatus, as described in the claim 1, wherein said recording/playing control unit has a recording program setup unit, which is configured to set up a program of recording, when said first contents information falls within a predetermined condition.

15. The video recording/playing apparatus, as described in the claim 14, wherein as said predetermined condition is included any one of a keyword, a genre, a channel and a time zone, each of which is set up by the user.

16. The video recording/playing apparatus, as described in the claim 1, wherein said contents are broadcast program, which is distributed during a predetermined time-period.

17. A video recording/playing method, for recording or playing video data, comprising the following steps of:
a step of extracting content information displaying contents from video data under reception or playback thereof, differing from said video data; and
a step of controlling recording or playing of a first contents corresponding to a first contents information, upon basis of said first contents information, which is extracted within said contents information extraction unit.
